(19) United States
(12) Patent Application Publication
(10) Pub. No.: US 2026/0093276 A1
(43) Pub. Date: Apr. 2, 2026

(54) CONTROL METHOD FOR MOVABLE DISPLAY SCREEN, ELECTRONIC DEVICE, AND STORAGE MEDIUM

(71) Applicant: Lenovo (Beijing) Limited, Beijing (CN)

(72) Inventor: Sujie DING, Beijing (CN)

(21) Appl. No.: 19/337,427

(22) Filed: Sep. 23, 2025

(30) Foreign Application Priority Data
Sep. 30, 2024 (CN) 202411388727.1

(51) Int. Cl. G05D 3/12; G06F 1/16; G06F 3/147; H04N 23/695; H04N 23/80

(52) U.S. Cl. CPC G05D 3/127; G06F 1/1652; G06F 3/147; H04N 23/695; H04N 23/80

(57) ABSTRACT

A control method includes receiving trigger information that initiates movement of the display screen, generating a driving signal based on the trigger information to control a drive motor that moves at least one end of the display screen and monitoring the state of a target limit switch configured to limit movement of the display screen to a target position. The driving signal controls a drive motor to move at least one end of the display screen. A first signal is generated based on a state of the target limit switch switching from a first state to a second state. The switching of the target limit switch from the first state to the second state indicates that a movement position of the display screen has changed from not reaching the target position to reaching the target position.

### CROSS-REFERENCE TO RELATED APPLICATION

This application claims priority of Chinese Patent Application No. 202411388727.1, filed on Sep. 30, 2024, the entire contents of which are hereby incorporated by reference.

### FIELD OF THE DISCLOSURE

The present disclosure generally relates to the field of information processing technology and, more particularly, relates to a control method and device for a movable display screen.

### BACKGROUND

A movable display screen refers to a rollable and portable display screen formed from a flexible display screen. The movable display screen can be rolled up and unfolded like a scroll to adjust a screen size.

In the art, a main control unit of a display device sends a trigger signal to initiate a roll-up or unfold operation of a movable display screen. However, it is difficult to precisely control whether the movable display screen fully completes the roll-up and unfolding operations, which may lead to malfunctions of the movable display screen.

### BRIEF SUMMARY OF THE DISCLOSURE

One aspect of the present disclosure provides a control method for a movable display screen. The control method includes: receiving trigger information that initiates movement of the display screen; generating a driving signal based on the trigger information, the driving signal being used to control an operation of a drive motor that drives at least one end of the display screen; monitoring a state of a target limit switch in the display screen, the target limit switch being configured to limit movement of the display screen to a target position; and generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

Another aspect of the present disclosure provides an electronic device. The electronic device includes one or more processors and a memory containing computer-readable instructions that, when being executed, cause the one or more processors to perform: receiving trigger information that triggers movement of the display screen; generating a driving signal based on the trigger information, the driving signal being configured to control operation of a drive motor to drive at least one end of the display screen to move; monitoring a state of a target limit switch in the display screen, the target limit switch being configured to limit movement of the display screen to a target position; and generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

Another aspect of the present disclosure provides a non-transitory computer readable storage medium containing computer-readable instructions that, when being executed, cause at least one processor to perform: receiving trigger information that triggers movement of the display screen; generating a driving signal based on the trigger information, the driving signal being configured to control operation of a drive motor to drive at least one end of the display screen to move; monitoring a state of a target limit switch in the display screen, the target limit switch being configured to limit movement of the display screen to a target position; and generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

Other aspects of the present disclosure can be understood by a person skilled in the art in light of the description, the claims, and accompanying drawings of the present disclosure.

### BRIEF DESCRIPTION OF THE DRAWINGS

The above and other features, advantages, and aspects of various embodiments of the present disclosure will become more apparent from the following detailed description, taken in conjunction with the accompanying drawings. Throughout the accompanying drawings, same or similar reference numbers refer to same or similar elements. It is to be understood that the accompanying drawings are schematic and not necessarily drawn to scale with respect to the components and elements shown.

FIG. 1 illustrates a schematic diagram of a movable display screen.

FIG. 2 illustrates a flowchart of a control method for a movable display screen consistent with various embodiments of the present disclosure.

FIG. 3 illustrates a schematic diagram of a support structure in a display screen consistent with various embodiments of the present disclosure.

FIG. 4 illustrates a schematic diagram of another support structure in a display screen consistent with various embodiments of the present disclosure.

FIG. 5 illustrates a schematic diagram showing a movement of a screen to a target position consistent with various embodiments of the present disclosure.

FIG. 6 illustrates another schematic diagram showing a movement of a screen to a target position consistent with various embodiments of the present disclosure.

FIG. 7 illustrates a flowchart for monitoring an operation of a drive motor consistent with various embodiments of the present disclosure.

FIG. 8 illustrates a schematic diagram of data generated by an encoder consistent with various embodiments of the present disclosure.

FIG. 9 illustrates a system diagram of an electronic device consistent with various embodiments of the present disclosure.

FIG. 10 illustrates a flowchart of a process of adjusting an image acquisition device to acquire images consistent with various embodiments of the present disclosure.

FIG. 11 illustrates a schematic diagram showing a relative positional relationship between the image acquisition device and an acquisition object consistent with various embodiments of the present disclosure.

FIG. 12 illustrates a schematic diagram of adjusting an acquisition range of the image acquisition device consistent with various embodiments of the present disclosure.

FIG. 13 illustrates a schematic diagram of a first image consistent with various embodiments of the present disclosure.

FIG. 14 illustrates a flowchart for controlling a movement of a display screen of an electronic device to trigger changes in a visible size of the display screen consistent with various embodiments of the present disclosure.

FIG. 15 illustrates a schematic diagram of an electronic device consistent with various embodiments of the present disclosure.

FIG. 16 illustrates another schematic diagram of an electronic device consistent with various embodiments of the present disclosure.

FIG. 17 illustrates a flowchart for intercepting and processing collected original images to obtain the first image consistent with various embodiments of the present disclosure.

FIG. 18 illustrates a schematic diagram of a display screen consistent with various embodiments of the present disclosure.

FIG. 19 illustrates a flowchart of dividing a display screen into display partitions consistent with various embodiments of the present disclosure.

FIG. 20 illustrates a schematic diagram of another display screen consistent with various embodiments of the present disclosure.

FIG. 21 illustrates a flowchart for controlling an output of second display content in a second display area of a display screen consistent with various embodiments of the present disclosure.

FIG. 22 illustrates another flowchart for controlling an output of second display content in a second display area of a display screen consistent with various embodiments of the present disclosure.

FIG. 23 illustrates a schematic diagram of a control device for a movable display screen consistent with various embodiments of the present disclosure.

FIG. 24 illustrates a schematic diagram of an electronic device consistent with various embodiments of the present disclosure.

### DETAILED DESCRIPTION

The embodiments of the present disclosure are described below with reference to the accompanying drawings. Terms used in the embodiments are intended solely to explain specific embodiments and do not limit the scope of the present disclosure.

The embodiments of the present disclosure will be described below with reference to the accompanying drawings. It will be understood by a person skilled in the art that, with the advancement of technology and the emergence of new scenarios, technical solutions provided by the embodiments of the present disclosure may also be applicable to similar technical problems.

Terms “first”, “second”, and the like, as used in the description and claims and accompanying drawings of the present disclosure, are employed solely to distinguish similar elements and are not intended to indicate any specific order or sequence. Such terms may be used interchangeably under appropriate circumstances and are merely used to differentiate elements with similar attributes in the embodiments of the present disclosure. Furthermore, terms “include” and “comprise” and any variations thereof, are intended to cover non-exclusive inclusions. Therefore, a process, method, system, product or apparatus containing a series of elements is not limited to the elements but may also include other elements not expressly listed or inherent to such process, method, system, product, or apparatus.

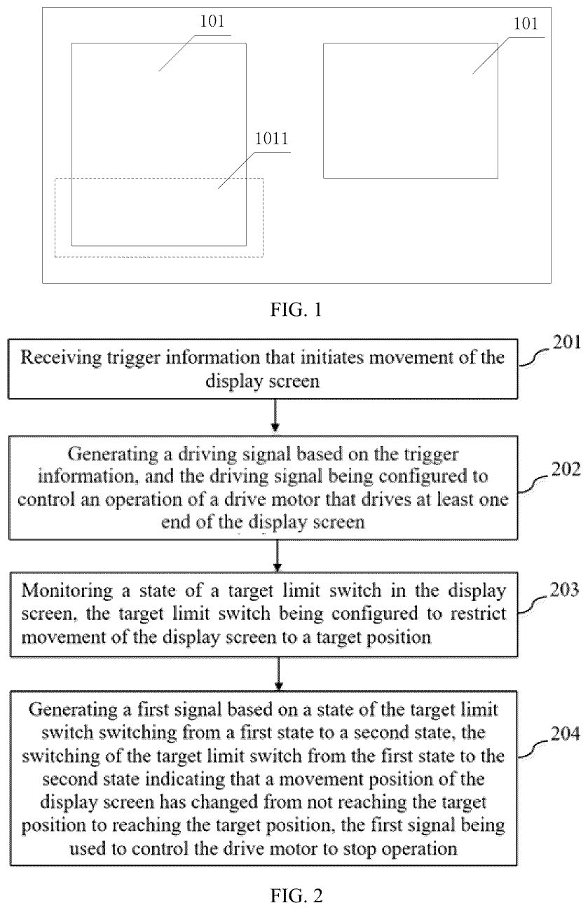

FIG. 1 illustrates a schematic diagram of a movable display screen. The diagram shows two screen sizes corresponding to states before and after a movement. In the present disclosure, the movement includes a roll-in and roll-out operation of the display screen.

A left-side illustration of FIG. 1 shows a display screen 101 before movement (e.g., before being rolled in), and a right-side illustration of FIG. 1 shows the display screen 101 after movement (e.g., after being rolled in). A visible size of the display screen before movement is larger than a visible size of the screen after movement. An area 1011, outlined by a dotted line in FIG. 1, represents an area of the display screen that can be rolled in. The area becomes hidden after the display screen is moved.

It should be noted that the schematic diagram is provided solely to illustrate a comparison before and after movement of the display screen. The schematic diagram depicts movement in a vertical (up and down) direction, which is not intended to limit the movement direction of the display screen. In practical applications, the display screen may move vertically or horizontally (left and right). The present disclosure imposes no limitation on the movement direction of the display screen.

FIG. 2 illustrates a flowchart of a control method for a movable display screen consistent with various embodiments of the present disclosure. The method may include steps from 201 to 204, which are described in detail below.

201: receiving trigger information that initiates movement of the display screen.

The display screen may be located on side B of a notebook computer or may be a separate monitor. The separate monitor may be connected to a host chassis to serve as an external display screen for the host.

In one embodiment, the control method for a movable display screen is executed by an electronic device. When the display screen is a display screen of side B of a notebook computer, the electronic device refers to the notebook computer. When the display screen is a separate monitor, the electronic device includes a device composed of a display and a host chassis. The electronic device is provided with a main control unit configured to control movement of the display screen. Accordingly, various types of information related to movement of the display screen are transmitted to the main control unit.

The trigger information may be obtained through an input device of the electronic device, such as a keyboard, mouse, touch screen, or the like.

The trigger information may be a specific key signal, a combination hotkey signal, a specific sliding gesture, or the like. The trigger information varies depending on a movement mode of the display screen.

In one embodiment, an electronic device sets function buttons (physical or virtual button) to control movement of the display screen, such as assigning different function buttons for different movement directions. Trigger information is generated when a corresponding function button is pressed or triggered.

In one embodiment, the electronic device may set hotkey combinations to control movement of the display screen, such as presetting different hotkey combinations for different movement directions. Trigger information is generated when a corresponding hotkey combination is pressed or triggered.

In one embodiment, the electronic device can set sliding gestures to control movement of the display screen, such as presetting different sliding gestures for different moving directions. Trigger information is generated when a corresponding sliding gesture is received.

202: generating a driving signal based on the trigger information, and the driving signal being configured to control an operation of a drive motor that drives at least one end of the display screen.

Based on the trigger information, it is determined that the display screen should be moved to adjust the visible size of the display screen.

When different triggering methods are configured for different movement directions of the display screen, corresponding trigger information may be obtained. Based on the received trigger information, the driving signal corresponding to the designated movement direction is generated.

Movement of the display screen is achieved by the drive motor moving at least one end of the display screen.

In one embodiment, a drive motor is arranged at one end of the display screen. The drive motor drives one end of the display screen, thereby concealing a portion of the display area corresponding to the driven end. If the electronic device is a laptop computer, the display screen typically moves only when the electronic device is in use and positioned in a specific posture. Therefore, after receiving the trigger information, the electronic device also detects current posture thereof. Step 202 is executed only if the detected posture matches a predefined, allowable movement posture.

The allowed movement posture of the electronic device is defined by a specific angle range between the display screen (side AB) and the base (side CD) of the electronic device.

In one embodiment, the specific angle range is between 90° and 120°.

The relative positions of the display screen and the base of the electronic device can be detected using sensors respectively installed on the screen and the base.

A sensor on the display screen can detect an angle between the display screen and a vertical direction, while a sensor on the base of the electronic device can detect an angle between the base of the electronic device and the vertical direction.

An angle between the display screen and the base of the electronic device is calculated using the following formula (1):

$$Angle = 180 ° - ( \vert base ∠ z \vert + \vert screen ∠ z \vert ) \qquad ( 1 )$$

In formula (1), the base ∠z denotes the angle between the base of the electronic device and the vertical direction, and the screen ∠z denotes the angle between the screen and the vertical direction.

If the angle between the screen and the base of the electronic device falls within a specified range, the electronic device is determined to be in an allowable movement posture, and step 202 is executed accordingly.

The driving signal may include a rotational speed control signal and a direction control signal. The rotational speed control signal is used to regulate a rotational speed of the drive motor, while the direction control signal is used to control the movement direction of the drive motor.

Optionally, in one embodiment, the speed control signal is implemented as a pulse width modulation (PWM) signal. The rotational speed of the drive motor is adjusted by varying a frequency of the PWM signal. A higher frequency results in a higher rotational speed, while a lower frequency results in a lower rotational speed.

Optionally, in one embodiment, the direction control signal is implemented as a general-purpose input and output interface (GPIO) signal. Different states of the GPIO signal correspond to different rotation directions of the drive motor. For example, a high-level GPIO signal may control the motor to rotate in the forward direction, while a low-level GPIO signal may cause the motor to rotate in the reverse direction.

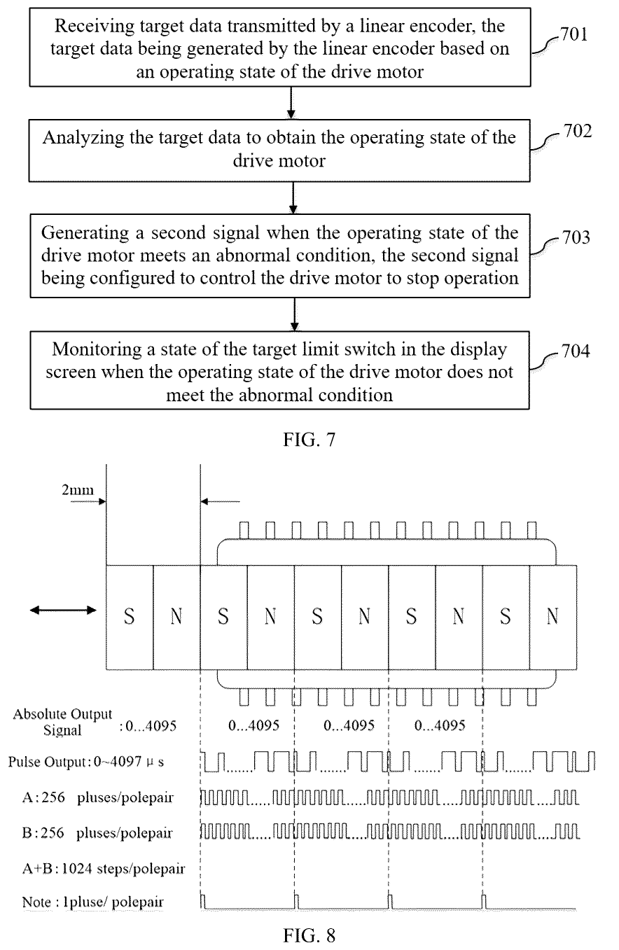

Optionally, in one embodiment, once the drive motor begins operating, a performance thereof is monitored to ensure that movement of the display screen proceeds normally. A detailed process of monitoring an operation of the drive motor is illustrated in FIG. 7.

203: monitoring a state of a target limit switch in the display screen, the target limit switch being configured to restrict movement of the display screen to a target position.

Limit switches are installed within the display screen to restrict movement of the display screen to specific positions. The specific positions include a farthest end and a closest end of a movement range of the display screen.

The display screen may adopt different structural configurations depending on a movement mode of the display screen. Accordingly, different types of limit switches are required for each structure to detect whether the display screen has reached a designated target position.

The display screen is a rollable type composed of a flexible display material, which can be rolled up and unfolded like a scroll. The display screen can be rolled from both ends toward a center or from one end toward the other end.

When the display screen is rolled from both ends toward the center, the movements at both ends must be monitored. If the display screen is rolled from only one end to the other end, only the rolled-up end needs to be monitored.

Correspondingly, when the display screen is rolled from both ends to the center, limit switches may be installed at both ends of the display screen to restrict the movement of each end to a target position. The target positions include both a fully rolled-up position and a fully unfolded position.

Similarly, when the display screen is rollable from one end toward the other end, a limit switch may be installed at a rolled-up end to restrict movement of the display screen to a target position. The target positions include both the fully rolled-up position and the fully unfolded position.

A target limit switch refers to a switch configured to restrict movement of the display screen to a target position. When the display screen is rolled up at least one end of the display screen, the limit switch corresponding to the rolled-up end reaching a limit position of the display screen is determined as the target limit switch. Similarly, when the display screen unfolds at least one end of the display screen, the limit switch corresponding to the unfolded end reaching a limit position of the display screen is determined as the target limit switch.

Optionally, in one embodiment, the display screen includes a flexible display screen and a support structure. The support structure provides mechanical support for the flexible display screen. Changes in a shape of the support structure drive corresponding changes in a shape of the flexible display screen, thereby enabling movement of the display screen, and resulting in changes in the visible size of the display screen.

In one embodiment, the support structure may be composed of two or more overlapping components. When the components overlap, the flexible display screen rolls up. When the components extend in a same plane without overlapping, the flexible screen unfolds.

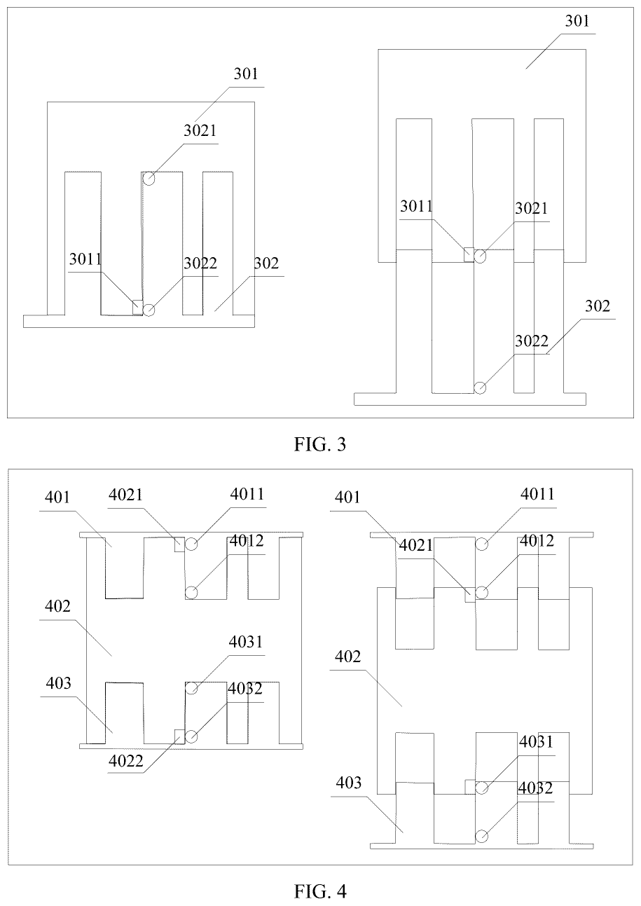

FIG. 3 illustrates a schematic diagram of a support structure in a display screen consistent with various embodiments of the present disclosure. The support structure is designed for a configuration in which the display screen rolls from one end to the other end. The support structure includes a first part 301 and a second part 302, which are capable of relative movement. In the schematic diagram, one end of the first part 301 is arranged with a contact piece 3011, while both ends of the second part 302 are arranged with respective limit switches 3021 and 3022. When the first part 301 overlaps the second part, one end of the flexible display screen is rolled up. As shown in a left-side illustration of FIG. 3, the contact piece 3011 on the first part 301 engages with the limit switch 3022 located at one end of the second part 302. Conversely, when the first and second parts extend along a same plane, the flexible display screen is unfolded. As shown in a right-side illustration of FIG. 3, the contact piece 3011 on the first part 301 engages with the limit switch 3021 located at the other end of the second part 302.

Correspondingly, when the display screen is rolled up from one end, the limit switch 3022 is determined as the target limit switch. When the display screen is unfolded from the rolled-up end, the limit switch 3021 is determined as the target limit switch.

FIG. 4 illustrates a schematic diagram of another support structure in a display screen consistent with various embodiments of the present disclosure. The support structure is configured to allow the display screen to be rolled from both ends toward the center. The support structure includes a first part 401, a second part 402, and a third part 403. The first part is movable relative to the second part, and the third part is movable relative to the second part. In the schematic diagram, the second part serves as a fixed structure, and the first part and the third part move toward the second part. One end of the second part is arranged with a contact piece 4021, and both ends of the first part are arranged with limit switches 4011 and 4012, respectively. The other end of the second part is arranged with a contact piece 4022, and both ends of the third part are arranged with limit switches 4031 and 4032, respectively. When the first part overlaps the second part, and the third part overlaps the second part, both ends of the flexible display screen of the display screen are rolled up. As shown in a left-side illustration of FIG. 4, the contact piece 4021 on the second part engages with the limit switch 4012 at one end of the first part, and the contact piece 4022 on the second part engages with the limit switch 4032 at one end of the third part. When the first, second and third parts extend along a same plane, the flexible display screen of the display screen is unfolded. As shown in a right-side illustration of FIG. 4, the contact piece 4021 on the second part engages with the limit switch 4011 at the other end of the first part, and the contact piece 4022 on the second part engages with the limit switch 4031 at one end of the third part.

Correspondingly, when the display screen is rolled up from both ends, the limit switch 4012 and the limit switch 4032 are determined as the target limit switches. When the display screen is unfolded from both ends, the limit switch 4011 and the limit switch 4031 are determined as the target limit switches.

204: generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

When the display screen reaches the target position, the state of the target limit switch changes from the first state to the second state.

In one potential embodiment, the limit switch may be a physical switch. Referring to the structures shown in FIGS. 3 and 4, the limit switch switches states upon contact with a corresponding contact piece.

In one embodiment, the first state of the limit switch may correspond to a high-level output, while the second state corresponds to a low-level output. Accordingly, the first state is represented by 1, and the second state by 0.

Upon detecting that the target limit switch transitions from the first state to the second state, it is determined that the display screen has reached the target position. Accordingly, the drive motor is controlled to stop operation and halt movement of the display screen.

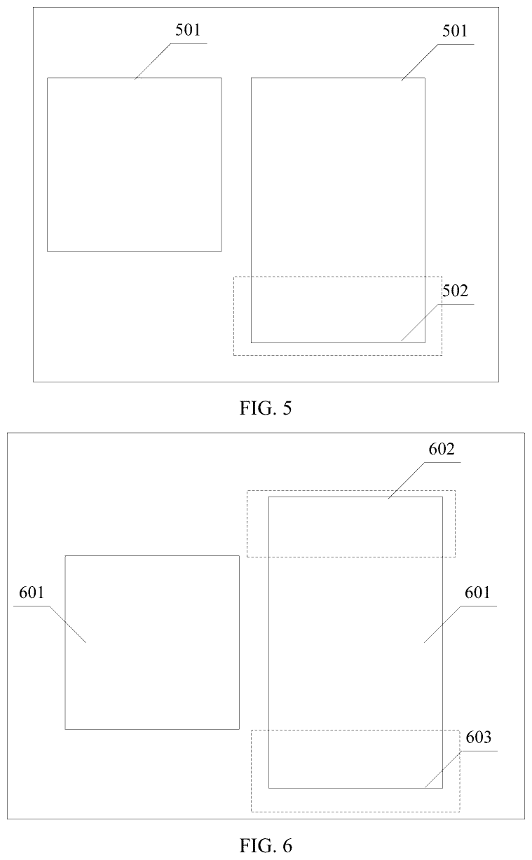

FIG. 5 illustrates a schematic diagram showing a movement of a screen to a target position consistent with various embodiments of the present disclosure. Movement of the display screen includes rolling up and unfolding from one end to the other end. A first end 501 of the display screen is fixed, while a second end 502 can roll up and unfold. A left-side illustration of FIG. 5 shows the display screen in the rolled-up state, where part of the display is hidden. A corresponding target position is when the second end 502 is fully retracted. A right-side illustration of FIG. 5 shows the display screen fully unfolded, with no hidden portions in the display screen. A corresponding target position is when the second end 502 is fully extended. A dotted line frame in FIG. 5 outlines an area that can be concealed.

FIG. 6 illustrates another schematic diagram showing a movement of a screen to a target position consistent with various embodiments of the present disclosure. Movement of the display screen includes rolling up and unfolding from both ends to a middle area. A middle position 601 of the display screen is fixed, while the two ends 602 and 603 can each be rolled up and unfolded toward the middle area. A left-side illustration of FIG. 6 shows the display screen in the rolled-up state, where part of the display is hidden. A corresponding target position is when both ends 602 and 603 are fully retracted. A right-side illustration of FIG. 6 shows the display screen is fully unfolded with no hidden portions in the display screen. A corresponding target position is when both ends 602 and 603 are fully extended. A dotted line frame in FIG. 6 outlines an area that can be concealed.

In one potential embodiment, when the display screen completes its movement, the visible size of the display screen changes. The change may cause an image acquisition device, positioned at one end of the device housing the display screen, to shift, potentially preventing the display screen from capturing images that meet the required criteria. Therefore, the images captured by the image acquisition device need to be adjusted. A process of adjusting the images captured by the image acquisition device is described in detail in FIG. 10.

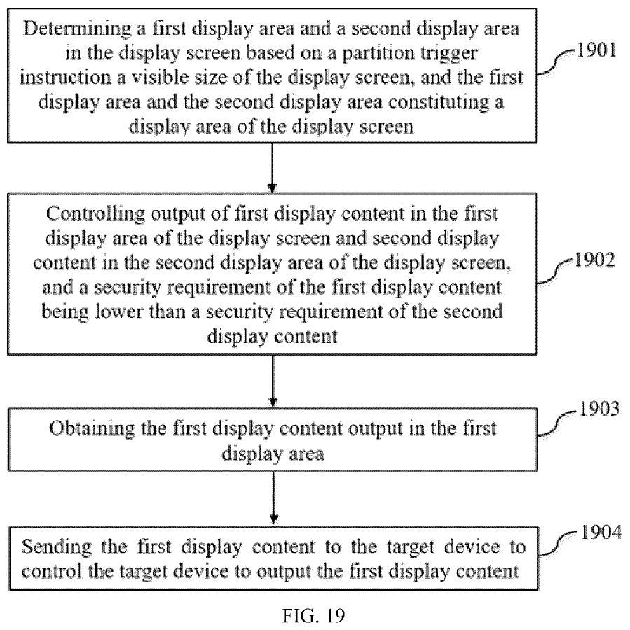

In one potential embodiment, after the display screen completes a movement, and the visible size of the display screen changes, the display screen can be divided into display areas, each serving different functions. A process of dividing the display screen into the functional display areas is described in detail in FIG. 19.

In one embodiment, upon receiving trigger information to initiate movement of the display screen, a drive signal is generated based on the trigger information to control the drive motor. An operation of the drive motor moves at least one end of the display screen, thereby changing the visible size of the display screen. During the operation of the drive motor, a state of the target limit switch in the display screen, used to restrict the display screen's movement to the target position, is continuously monitored. If the state of the target limit switch changes from a first state to a second state, indicating that the movement position of the display screen has transitioned from not reaching the target position to reaching the target position, a first signal is generated. The first signal is used to control the drive motor to stop operating, thereby enabling precise control of movement of the display screen and preventing under-rolling, over-rolling, or incomplete unfolding.

FIG. 7 illustrates a flowchart for monitoring an operation of a drive motor consistent with various embodiments of the present disclosure. The process may include steps from 701 to 704, which are described in detail below.

701: receiving target data transmitted by a linear encoder, the target data being generated by the linear encoder based on an operating state of the drive motor.

After a drive signal is generated to control the drive motor, the operation of the drive motor is monitored accordingly.

In one embodiment, the linear encoder is configured for the drive motor to generate data signals corresponding to the operation of the drive motor. The data signals can be used to analyze the operating state of the drive motor.

In one embodiment, the linear encoder may operate in an absolute output mode.

During operation, the drive motor moves the flexible display screen, which in turn drives a magnetic belt of the linear encoder. The magnetic belt contains evenly spaced magnetic field regions of south and north poles. As the belt moves, a magnetic field detected by the linear encoder changes. A magnetic sensing range of the linear encoder is pre-divided into a specific number of coded segments. Changes in the magnetic field detected by the linear encoder correspond to a movement speed of the drive motor. The linear encoder can upload coded data at predefined intervals, with each uploaded code representing a drive motor's movement during an interval. The coded data, reflecting magnetic field variations, allows a main control unit of the electronic device to determine the operational state of the drive motor.

FIG. 8 illustrates a schematic diagram of data generated by an encoder consistent with various embodiments of the present disclosure. The linear encoder includes a magnet belt 801, which is uniformly embedded with multiple magnetic poles, specifically alternating south(S) and north (N) poles. In the schematic diagram, each pair of magnetic poles spans a 2 mm range. The linear encoder operates in absolute output mode, where each 2 mm range is subdivided into 4096 partitions, corresponding to codes from 0 to 4095. Therefore, the absolute output signal ranges from 0 to 4095. Additionally, the encoder can provide a pulse-width modulation (PWM) output signal ranging from 0 to 4097 μs (microseconds). The drive motor rotates to move the magnet strip in the linear encoder, causing it to cut through magnetic lines of force. For each pair of magnetic poles, number of electrical pulses (pulses/pole pair) is recorded at two positions, A and B. The encoder parameters are set so that both Phase A and Phase B generate 256 pulses per magnetic pole pair. Consequently, the total number of steps per magnetic pole pair (Phase A+Phase B) is 1024 steps/pole pair. Additionally, index information is used to identify each magnetic pole pair, with one index pulse generated per pole pair (1 pulse/pole pair). A bidirectional arrow in FIG. 8 indicates possible directions of movement of the magnet belt.

Correspondingly, the acquired number of electrical pulses per magnetic pole pair, the number of steps per magnetic pole pair, and index marking information can be transmitted to the main control unit as target data.

702: analyzing the target data to obtain the operating state of the drive motor.

The main control unit is preconfigured with analysis rules. Based on the target data transmitted by the linear encoder, the main control unit analyzes and determines the current operating state of the drive motor.

After being turned on, the drive motor gradually accelerates over a period. Once the drive motor reaches a set speed, the drive motor can rotate at a relatively constant rate, thereby achieving normal operation.

Correspondingly, analyzing the target data allows determination of whether the magnet belt in the linear encoder is moving at a uniform speed.

In one potential embodiment, target data collected during the initial acceleration period after the drive motor is turned on may be discarded to prevent interference from a startup process when determining uniform motion.

If the target data received from the linear encoder indicates that the magnet belt is moving at a uniform speed, the drive motor is determined to operate normally without abnormal conditions and step 704 is executed.

Conversely, if the target data indicates that the magnet belt is not moving at a uniform speed, that is, if the magnet belt is stationary, the drive motor is determined to have failed to start successfully, indicating an abnormal operating condition, and step 703 is executed.

During the movement of the movable display screen, two or more motors may be arranged at one end of the movement. The two or more motors operate synchronously to drive movement of the display screen. Each drive motor is paired with the linear encoder, which generates target data reflecting an operation of a corresponding drive motor.

Based on the target data from each linear encoder, it can be determined whether the motors are moving synchronously. Specifically, the speed of the magnet belt for each linear encoder is analyzed and compared. If the speeds are identical, the motors are considered synchronized. If not, the motors are unsynchronized, which is regarded as an abnormal condition, and step 703 is executed.

703: generating a second signal when the operating state of the drive motor meets an abnormal condition, the second signal being configured to control the drive motor to stop operation.

If an abnormal operating condition is detected, the drive motor is stopped to prevent further operation, thereby helping to protect the movable display screen and extend a service life of the display screen.

A second control signal is generated and transmitted to each drive motor to stop movement of the display screen.

In addition, if the operating state of the drive motor satisfies a predefined abnormal reporting condition, an alarm signal is generated and output to indicate the abnormal operating state of the drive motor, thereby enabling a user to promptly recognize the abnormal condition.

704: monitoring a state of the target limit switch in the display screen when the operating state of the drive motor does not meet the abnormal condition.

If it is determined that the operating state of the drive motor does not satisfy any abnormal condition and that the display screen is capable of normal movement, the operating state of the drive motor continues to be monitored based on subsequently received target data. Simultaneously, the state of the target limit switch in the display screen is monitored to determine whether the display screen has reached a target position during a normal movement of the display screen.

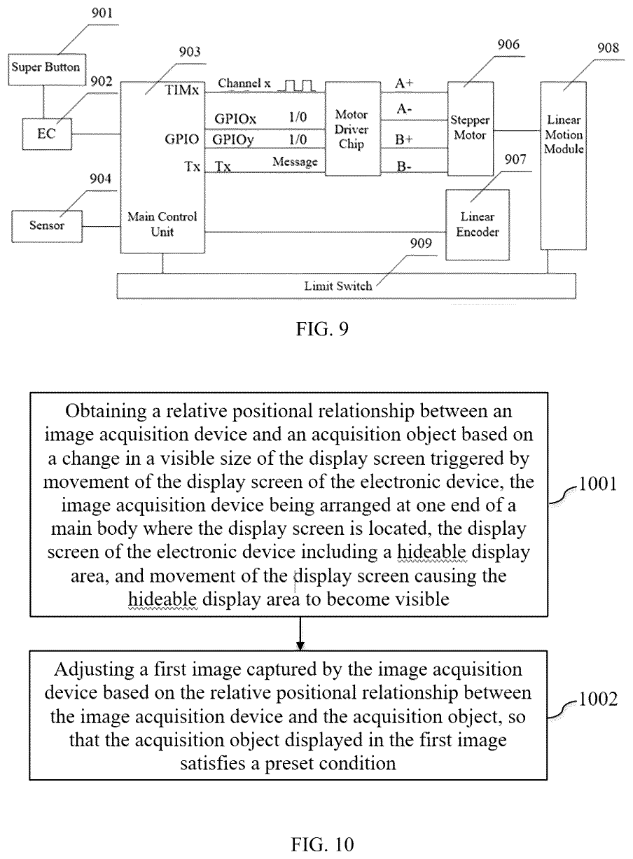

FIG. 9 illustrates a system diagram of an electronic device consistent with various embodiments of the present disclosure. The electronic device may include: a super button 901, an embedded controller (EC) 902, a main control unit 903, a sensor 904, a motor driver chip 905, a stepper motor 906, a linear encoder 907, a linear motion module 908 and a limit switch 909.

The super button 901 is connected to the main control unit 903 through the EC902. When the super button 901 is triggered, the super button 901 generates a signal to the EC902, which in turn sends a trigger signal to the main control unit 903 to initiate movement of the display screen.

The sensor 904 is connected to the main control unit 903. The sensor 904 is configured to detect a posture of the electronic device, such as an opening or closing angle between a screen (side AB) and a base (side CD) of a notebook computer.

The main control unit 903 is connected to the motor driver chip 905 through a TIMx pin, two GPIO pins, and a Tx pin. The TIMx pin is a channel x configured to transmit pulse signals between the main control unit 903 and the motor driver chip 905. A GPIOx pin is used to adjust a rotation direction of the motor based on a high- or low-level signal. A GPIOy pin is used to enable or disable the motor driver based on a high- or low-level signal. The Tx pin is used to transmit configuration parameter messages to the motor driver chip 905. The main control unit 903 determines whether to control movement of the display screen based on the received trigger signal and a detected opening or closing angle.

The motor driver chip 905 is connected to the stepper motor 906 through two pairs of signal paths configured to transmit A+, A−, B+, and B− signals, respectively. The stepper motor 906 rotates based on signals transmitted from the motor driver chip 905. The linear encoder 907 feeds back target data generated based on an operating state of the stepper motor 906 to the main control unit 903. The main control unit 903 determines, based on the target data, whether to control the stepper motor 906 to continue operating or to stop operating through the motor drive signal.

The stepper motor 906 drives the linear motion module 908 configured to move the display screen.

The linear motion module 908 is coupled with a limit switch. When the display screen reaches the target position, the limit switch changes state. The main control unit 903 detects the state change in the limit switch and generates a stop control signal to the motor driver chip 905, causing the stepper motor 906 to stop operating.

In one embodiment, the operation of the drive motor is monitored through the linear encoder. Specifically, target data generated by the linear encoder based on the operating state of the drive motor is received and analyzed to determine the operating state of the drive motor. If the operating state of the drive motor meets an abnormal condition, a second signal is generated. The second signal is configured to stop operation of the drive motor. If the operating state of the drive motor does not meet an abnormal condition, a step of monitoring the state of a target limit switch in the display screen is performed, thereby enabling continuous monitoring of the drive motor during the operation of the drive motor to track movement of the display screen and extend the service life of the display screen.

FIG. 10 illustrates a flowchart of a process of adjusting an image acquisition device to acquire images consistent with various embodiments of the present disclosure. The process may include steps 1001 and 1002, which are described in detail below.

1001: obtaining a relative positional relationship between an image acquisition device and an acquisition object based on a change in a visible size of the display screen triggered by movement of the display screen of the electronic device, the image acquisition device being arranged at one end of a main body where the display screen is located, the display screen of the electronic device including a hideable display area, and movement of the display screen causing the hideable display area to become visible.

Movement of the display screen of the electronic device may trigger a change in the visible size of the display screen. Certain areas of the display screen correspond to hideable display areas. Movement of the display screen enables exposure of the hideable display area, thereby increasing the visible size of the display screen. The visible size of the display screen prior to the movement is smaller than the visible size of the display screen after the movement. The visible size of the display screen may correspond to the visible size of the display screen illustrated in FIG. 1.

In one embodiment, the visible sizes of the display screen include 13.9 inches and 16.7 inches. The 13.9-inch display screen has an aspect ratio of 5:4 and a resolution of 2000×1600 pixels. The 16.7-inch display screen has an aspect ratio of 8:9 and a resolution of 2000×2350 pixels.

An image acquisition device is arranged at one end of the main body of the electronic device where the display screen is located. The image acquisition device is configured to capture images of an acquisition object.

When the visible size of the display screen changes during image acquisition of the acquisition object, an acquisition range of the image acquisition device also changes. Consequently, the relative positional relationship between the image acquisition device and the acquisition object changes, resulting in variations in the acquired image of the acquisition object.

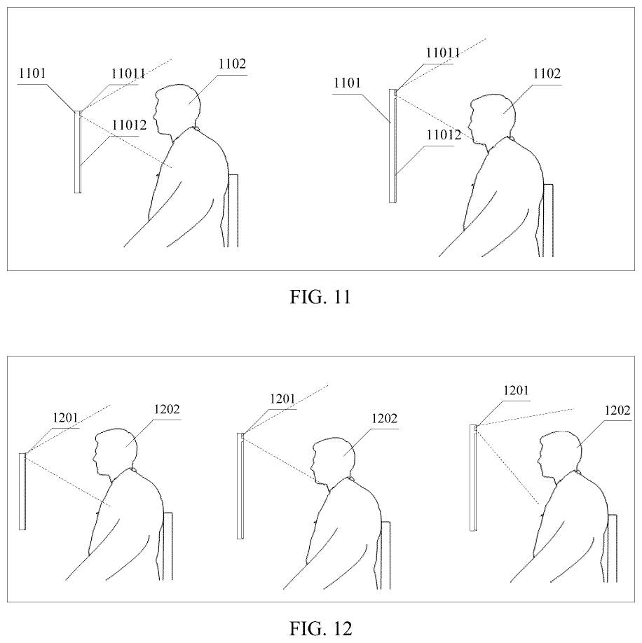

FIG. 11 illustrates a schematic diagram showing a relative positional relationship between the image acquisition device and an acquisition object consistent with various embodiments of the present disclosure. The schematic diagram includes an electronic device 1101 and an acquisition object 1102. In one embodiment illustrated in FIG. 11, the acquisition object is a person. The electronic device includes an image acquisition device 11011 and a display screen 11012. The image acquisition device is on an upper side of the display screen. The display screen can vary the visible size of the display screen in an up-and-down direction. A left-side illustration of FIG. 11 shows the relative positional relationship between the image acquisition device and the acquisition object prior to a change in the visible size of the display screen, in which the acquisition object is in a central area of the acquisition range of the image acquisition device. A right-side illustration of FIG. 11 shows the relative positional relationship between the image acquisition device and the acquisition object after the visible size of the display screen has changed, in which the acquisition object is in a lower area of the acquisition range of the image acquisition device.

In one potential embodiment, different changes in the visible size of the display screen may be based on different trigger instructions. A process of controlling changes in the visible size of the display screen is described in detail in FIG. 14.

1002: adjusting a first image captured by the image acquisition device based on the relative positional relationship between the image acquisition device and the acquisition object, so that the acquisition object displayed in the first image satisfies a preset condition.

The preset condition is to maintain a presentation effect of the acquisition object in the image that corresponds to the presentation effect prior to the change in the visible size of the display screen.

A change in the visible size of the display screen causes a corresponding change in the relative positional relationship between the image acquisition device and the acquisition object. If the image acquisition device continues to apply the image processing method used prior to the change in visible screen size, the acquisition object in the resulting image may fail to meet the preset condition. Accordingly, it is necessary to adjust the first image acquired by the image acquisition device so that the acquisition object displayed in the first image satisfies the preset condition.

In one potential embodiment, adjusting the first image acquired by the image acquisition device so that the acquisition object displayed in the first image satisfies the preset condition includes at least one of the following operations:

1: adjusting the acquisition range of the image acquisition device so that the acquisition object displayed in the first image satisfies the preset condition.

2: cropping and processing the originally acquired image to obtain the first image, so that the acquisition object displayed in the first image satisfies the preset condition.

The acquisition object displayed in the first image captured by the image acquisition device satisfies the preset condition, which includes at least one of the following: a position of the acquisition object in the first image is in a central area of the first image; and a viewing direction of the acquisition object in the first image is toward the display screen.

The relative positional relationship between the image acquisition device and the main body is changeable, and an acquisition angle of the image acquisition device is adjustable. Accordingly, the acquisition range of the image acquisition device can be adjusted by modifying a relative angle between the image acquisition device and a specific surface of the main body where the display screen is located.

By adjusting the acquisition range of the image acquisition device, in the first image captured by the image acquisition device, the position of the acquisition object in the first image is in the central area of the first image, and the presentation effect is consistent with the presentation effect before the visible size of the screen changes

FIG. 12 illustrates a schematic diagram of adjusting an acquisition range of the image acquisition device consistent with various embodiments of the present disclosure. A left-side illustration of FIG. 12 shows the acquisition range of the image acquisition device 1201 prior to the change in visible screen size, in which the acquisition object 1202 is in the central area of the acquisition range. A middle illustration shows the acquisition range of the image acquisition device 1201 after the visible size of the screen has changed, in which the acquisition object 1202 is in a lower area of the acquisition range. A right-side illustration shows the acquisition range of the image acquisition device 1201 after an adjustment, in which the acquisition object 1202 is in the central area of the acquisition range.

If the acquisition angle of the image acquisition device is not adjustable, the original image captured by the image acquisition device may be intercepted so that the acquisition object is in the central area of the resulting first image. A presentation effect of the acquisition object in the first image is consistent with a presentation effect prior to the change in the visible size of the display screen.

In one potential embodiment, auto-framing technology may be employed to intercept the original image captured by the image acquisition device. The acquisition object is used as a focal point for interception, so that in the intercepted first image, the acquisition object is in the central area of the first image.

In one potential embodiment, the first image may also be processed so that the viewing direction of the acquisition object in the first image is toward the display screen.

When the acquisition object is a human face, eye-tracking technology may be employed to process a facial image in the first image, so that a line-of-sight direction of the face is adjusted to be oriented toward the display screen.

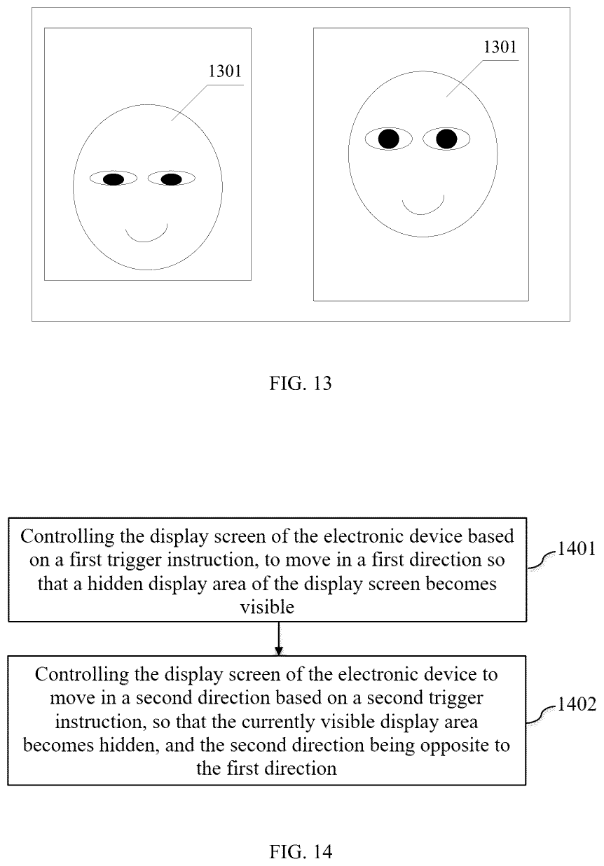

FIG. 13 illustrates a schematic diagram of the first image consistent with various embodiments of the present disclosure. A left-side illustration of FIG. 13 is a schematic diagram of the first image prior to adjustment. The acquisition object 1301 is in a lower portion of the image, and a line-of-sight direction of the acquisition object is downward. A right-side illustration of FIG. 13 is a schematic diagram of the first image after adjustment. The acquisition object 1301 is in the central area of the first image, and the line-of-sight direction of the acquisition object is oriented toward the display screen.

It should be noted that, in one embodiment, movement of the display screen may cause a previously hidden display area to become visible, resulting in a change in the visible size of the display screen from a smaller size to a larger size. Similarly, a same processing method can be applied when movement of the display screen causes previously visible display area to become hidden, resulting in a change in the visible size of the display screen from a larger size to a smaller size. Details of the same processing method are not repeated herein.

The embodiment further includes obtaining the relative positional relationship between the image acquisition device and the acquisition object based on a change in the visible size of the screen triggered by movement of the display screen of the electronic device. The image acquisition device is arranged at one end of the main body where the display screen of the electronic device is located. The display screen of the electronic device includes a hideable display area, and movement of the display screen may cause the hideable display area to become visible. Based on the relative positional relationship between the image acquisition device and the acquisition object, the first image captured by the image acquisition device is adjusted so that the acquisition object displayed in the first image satisfies the preset condition. Movement of the display screen is controlled to trigger a change in the visible size of the screen, which in turn causes a change in the relative positional relationship between the image acquisition device and the acquisition object. The image acquisition device is disposed at one end of the main body where the display screen is located. The first image obtained by the image acquisition device for the acquisition object exhibits a degraded presentation effect compared to the image obtained before the visible size of the screen changes. Accordingly, the first image acquired by the image acquisition device is adjusted so that the acquisition object displayed therein satisfies the preset condition and achieves a presentation effect consistent with a presentation effect of the image captured prior to the change in the visible screen size, thereby improving a quality of image acquisition

FIG. 14 illustrates a flowchart for controlling movement of the display screen of the electronic device to trigger changes in the visible size of the display screen consistent with various embodiments of the present disclosure. A process of controlling movement of the display screen of the electronic device to trigger changes in the visible size of the display screen includes steps 1401 and 1402, which are described in detail below.

1401: controlling the display screen of the electronic device based on a first trigger instruction, to move in a first direction so that a hidden display area of the display screen becomes visible.

Different movement directions of the display screen are controlled in response to different trigger instructions.

Different keys, hotkey combinations and sliding gestures can be used to generate different trigger instructions.

Upon receiving a trigger instruction, a corresponding control direction is determined based on the instruction, and the display screen is controlled to move in a corresponding direction.

The first direction refers to a direction in which the display screen is unfolded. In the first direction, the display screen transitions from a rolled-up state to an unfolded state, thereby rendering a previously hidden display area visible and realizing a change in the display screen from being partially rolled and hidden to being fully unfolded.

1402: controlling the display screen of the electronic device to move in a second direction based on a second trigger instruction, so that the currently visible display area becomes hidden, and the second direction being opposite to the first direction.

The electronic device includes a first body and a second body. The display screen includes a visible display area arranged on the first body and a hideable display area arranged on the second body. The image acquisition device is located at one end of the first body.

The second direction corresponds to a rolling-up direction of the display screen. In the second direction, the display screen transitions from an unfolded state to a rolled-up state, so that the hideable display area of the display screen becomes hidden, thereby realizing a change in the display screen from being fully unfolded to being partially rolled up and hidden.

To enable the hideable display area to transition between visible and hidden states, the electronic device includes a first body and a second body. The visible display area of the display screen is provided on the first body, while the hideable display area is provided on the second body. The display area on the first body remains constantly visible. The image acquisition device is arranged at one end of the first body. As the hideable display area transitions between hidden and visible states, an overall size of the display screen changes accordingly. Correspondingly, a distance between the surface of the image acquisition device and the display screen surface varies, resulting in a change in the relative positional relationship between the image acquisition device and the acquisition object.

The first body and the second body may be connected through a rotating shaft. One end of the first body is arranged with the image acquisition device, while the other end of the first body is connected to the second body through the rotating shaft.

The electronic device may be a notebook computer, in which the first body corresponds to the AB side and the second body corresponds to the CD side. The display screen is located on the A side, and the hideable display area is concealed within the second body.

When the entire display area of the display screen is visible, a distance between one end and the other end of the first body is relatively large. Conversely, when a portion of the display screen becomes hidden and is carried by the second body, the distance between the two ends of the first body becomes smaller.

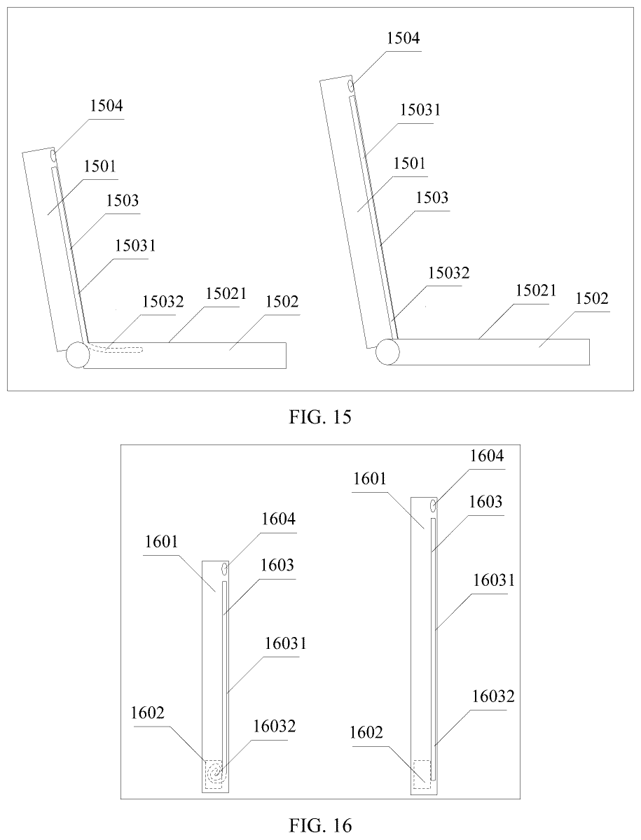

FIG. 15 illustrates a schematic diagram of an electronic device consistent with various embodiments of the present disclosure. FIG. 15 is a side view of the electronic device. The electronic device includes a first body 1501 and a second body 1502, which are rotatably connected. A side 15021 of the second body 1502, adjacent to the first body 1501, may be arranged with input devices such as buttons, touchpads, or the like. A first display area 15031 of the display screen 1503 is arranged on the first body 1501, while a second display area 15032 is arranged on the second body 1502. An image acquisition device 1504 is arranged on the first body 1501. In a left-side illustration of FIG. 15, the second display area of the display screen is hidden, resulting in a partially concealed display screen. In a right-side illustration of FIG. 15, both the first and second display areas are visible, and the display screen is fully expanded.

The second body may be arranged within the first body and is configured to carry the hideable display area of the display screen. The first body includes an internal carrying space for accommodating the second body.

FIG. 16 illustrates another schematic diagram of an electronic device consistent with various embodiments of the present disclosure. FIG. 16 is a side view of an electronic device comprising a first body 1601 and a second body 1602. The second body 1602 is arranged within the first body 1601. The display screen 1603 includes a first display area 16031 on the first body 1601 and a second display area 16032 on the second body 1602. An image acquisition device 1604 is also arranged on the first body 1601. In a left-side illustration of FIG. 16, the second display area of the display screen is hidden, resulting in a partially concealed display screen. In a right-side illustration of FIG. 16, both the second display area and the first display area of the display screen are simultaneously visible, and the display screen is fully expanded.

In one embodiment, the electronic device includes a first body and a second body. The display screen includes a visible display area arranged on the first body and a hideable display area arranged on the second body. The image acquisition device is on the first body. In response to the first triggering instruction, the display screen is controlled to move in the first direction, causing the hidden display area to become visible. In response to the second triggering instruction, the display screen is controlled to move in the second direction, causing the visible display area to become hidden. The second direction is opposite to the first direction. The first body and the second body of the electronic device respectively carry the visible display area and the hideable display area of the display screen. Upon receiving different trigger instructions, the display screen of the electronic device can be controlled to move in corresponding directions, causing the hideable display area to switch between hidden and visible states. As a result, the display screen adjusts to different sizes.

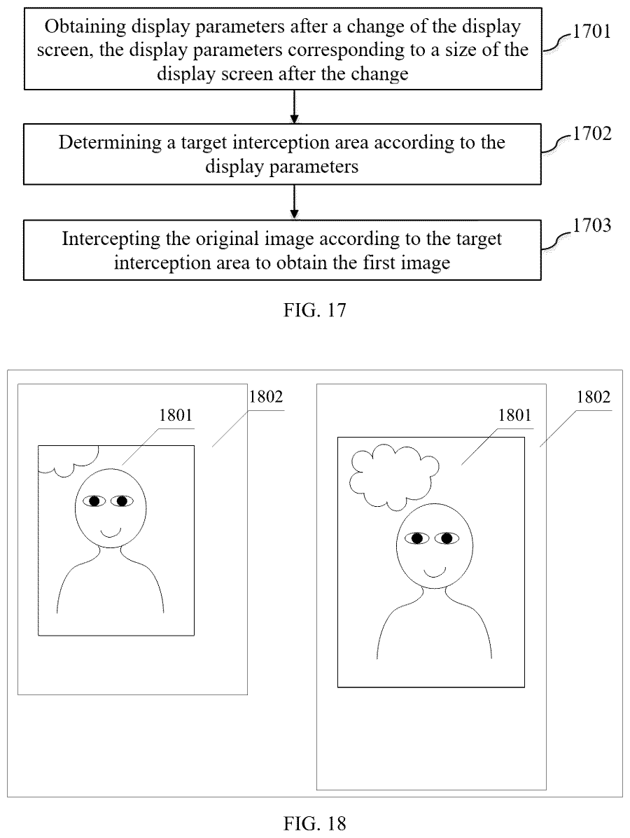

FIG. 17 illustrates a flowchart for intercepting and processing collected original images to obtain the first image consistent with various embodiments of the present disclosure. A process of intercepting and processing collected original images to obtain the first image includes steps from 1701 to 1703, which are described in detail below.

1701: obtaining display parameters after a change of the display screen, the display parameters corresponding to a size of the display screen after the change.

The display parameters may include display-related parameters such as an aspect ratio of the display screen and number of pixels.

When the movement of the display screen triggers a change in the visible size of the display screen, display parameters before the change differ from display parameters after the change.

For example, the visible size of the display screen before the change is smaller than the visible size of the screen after the change. Correspondingly, the number of pixels on the display screen before the change is less than the number of pixels on the display screen after the change, and the aspect ratios of the visible size of the display screen before the change and the visible size of the display screen after the change differ. Conversely, the visible size of the screen before the change of the display screen may be greater than the visible size of the screen after the change. Correspondingly, the number of pixels on the display screen before the change is greater than the number of pixels on the display screen after the change, and the aspect ratios of the visible size of the display screen before the change and the visible size of the display screen after the change differ.

The current interception rule used to intercept the original image corresponds to the display parameters before the display screen changes. However, the rule is not suitable for the display parameters after the display screen changes. Therefore, the original image needs to be intercepted based on the updated display parameters.

The display parameters after the change of the display screen are obtained, and the display parameters include various parameters required for image interception, which are not limited herein.

1702: determining a target interception area according to the display parameters.

The interception rule uses auto-framing technology, which determines a target interception area based on the display parameters.

Because the visible size of the display screen before the change differs from the visible size of the display screen after the change, the auto-framing technology can determine different interception areas corresponding to the visible sizes of the display screen before and after the change, ensuring the interception area matches the current visible screen size.

1703: intercepting the original image according to the target interception area to obtain the first image.

Based on the determined target interception area, a portion of the original image containing the acquisition object is identified and intercepted to obtain the first image.

In one potential embodiment, the original image may be a circular or hemispherical image captured by the image acquisition device.

During an interception process, the original image can also be processed in conjunction with the method illustrated in FIG. 10.

In the auto-framing technology, an interception range of a specific object can be set within an image content.

For example, when the acquisition object in the original image is a person, an area from the head to the chest can be intercepted to obtain the first image. Correspondingly, for different visible sizes of the display screen, to ensure a captured portrait is not distorted, a capture ratio can be adjusted. For example, for a display screen with a large length-to-width ratio, an interception range with a similarly large length-to-width can be selected. The interception range may include areas above the head or below the chest in the original image, thereby obtaining the first image that better fits the display screen.

FIG. 18 illustrates a schematic diagram of a display screen consistent with various embodiments of the present disclosure. A first image 1801 is displayed on the display screen. In FIG. 18, a left-side illustration shows the display screen 1802 at a first size, while a right-side illustration shows the display screen 1802 at a second size. The first size is larger than the second size, and the length-to-width ratios of the first and second sizes differ. The length-to-width ratio of the first image in the left-side illustration corresponds to the display screen at the first size, whereas the length-to-width ratio of the first image in the right-side illustration corresponds to the display screen at the second size. Additionally, the first image in the left-side illustration is smaller than the first image in the right-side illustration. Moreover, the length-to-width ratio of the first size is smaller than the length-to-width ratio of the second size. An area above the head of the portrait in the first image in the left-side illustration is smaller than an area above the head of the portrait in the first image in the right-side illustration. However, under a premise of ensuring that the length-to-width ratio of the first image remains consistent with the length-to-width ratio of the display screen, the portrait in the first image is not deformed.

In one embodiment, the display parameters after the change of the display screen are obtained, corresponding to the size of the display screen after the change. A target interception area is determined according to the display parameters. The original image is intercepted according to the target interception area to obtain the first image, and the first image is determined according to the display parameters after the change of the display screen. The target interception area is used to extract the first image from the original image. Parameters are adjusted based on the interception rule preset in the electronic device, so that the intercepted first image matches the visible size of the screen after the change in the display screen, thereby ensuring improved presentation quality of the displayed image.

FIG. 19 illustrates a flowchart of dividing a display screen into display partitions consistent with various embodiments of the present disclosure. A process of dividing a display screen into display partitions includes steps from 1901 to 1904, which are described in detail below.

1901: determining a first display area and a second display area in the display screen based on a partition trigger instruction a visible size of the display screen, and the first display area and the second display area constituting a display area of the display screen.

A partition triggering instruction may be generated based on key values of specific hotkey combinations, input gestures or tracks, function key inputs, or the like.

In one embodiment, a hotkey combination, such as “Alt+W”, may be designated as a function key to trigger a partition.

In one possible implementation, when the display screen is fully expanded and the previously hidden display area becomes visible, a received partition trigger instruction causes the display screen to be divided into two display areas.

Correspondingly, the hideable display area in the display screen may be designated as the second display area, while the non-hideable display area in the display screen may be designated as the first display area.

Upon receiving the partition triggering instruction, the display screen is divided into two display areas based on the current visible size of the display screen.

In one potential embodiment, the partition triggering instruction may include partition information, and the visible display screen is partitioned according to the received partition information.

The two display areas in the display screen are respectively configured to output different display contents.

When the display screen is rolled or unfolded in a left-right direction, the first display area and the second display area may be arranged in the left-right direction on the display screen. When the display screen is rolled or unfolded in an up-down direction, the first display area and the second display area may be arranged in the up-down direction on the display screen.

In one potential embodiment, an area of the first display area is larger than an area of the second display area, thereby enhancing display performance when display content is output to a target device.

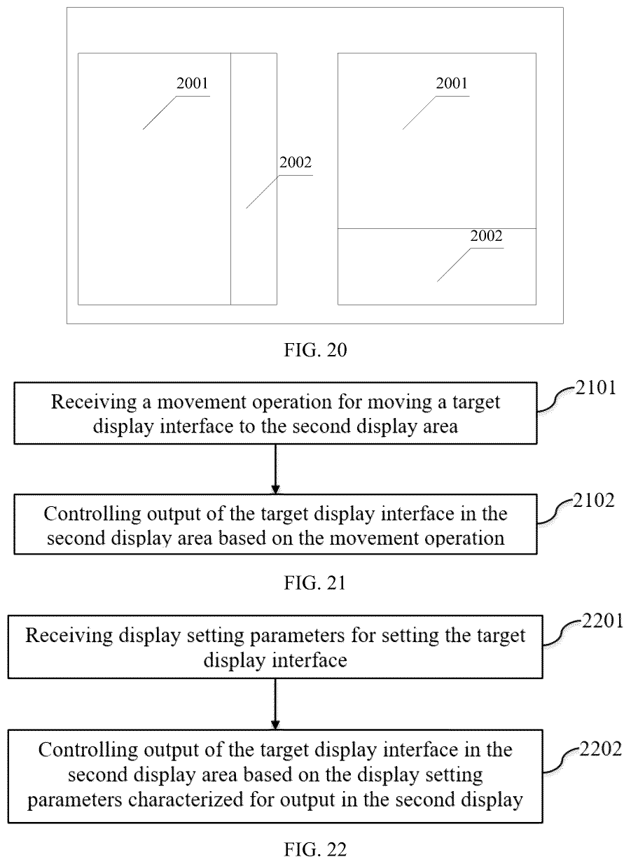

FIG. 20 illustrates a schematic diagram of another display screen consistent with various embodiments of the present disclosure. The display screen includes a first display area 2001 and a second display area 2002. In a left-side illustration of FIG. 20, the two display areas are arranged horizontally (left-right), while in the right-side illustration, they are arranged vertically (up-down).

In one potential embodiment, if the partition triggering instruction is not received, all display content in the display screen is sent to the target device, which is controlled to output the entire display content.

1902: controlling output of first display content in the first display area of the display screen and second display content in the second display area of the display screen, and a security requirement of the first display content being lower than a security requirement of the second display content.

Different display contents are distributed and output in the first display area and the second display area, and the security requirement of the first display content is lower than the security requirement of the second display content.

In one embodiment, the content displayed in the first display area may include application pages with a relatively low security requirement, such as a web conferencing page, a screen casting page, or the like.

The content output by the second display area is an application page with a relatively high security requirement, such as instant messaging pages, user personal information pages or other information.

In one potential embodiment, a target display interface can be moved to the second display area to control the output of the display content in the second display area. A process of controlling the output of the second display content in the second display area of the display screen is described in detail in FIG. 21.

In one potential embodiment, the display parameters of the target display interface can be preset to display within the second display area. Accordingly, the target display interface can be automatically output in the second display area. A process of controlling the output of the second display content in the second display area of the display screen is described in detail below in FIG. 22.

1903: obtaining the first display content output in the first display area.

The first display content of the first display area can be obtained by capturing a screenshot.

1904: sending the first display content to the target device to control the target device to output the first display content.

A data transmission channel is established between the electronic device and the target device. The connection between the electronic device and the target device may be a wired connection, such as via a bus interface, or a wireless connection, such as through Bluetooth.

The first display content is transmitted to the target device through a data transmission channel between the electronic device and the target device. The target device performs display output based on the received first display content, thereby enabling projection of the content displayed on the display screen of the electronic device onto the target device.

The target device may be a peer device arranged with an application terminal, such as a terminal device of another participant in an online conference or may be a device used for screen projection.

In one embodiment, based on receiving the partition triggering instruction and based on the visible size of the display screen, the first display area and the second display area in the display screen are determined. The first display area and the second display area constitute the display area of the display screen. An output of the first display content in the first display area of the display screen and an output of the second display content in the second display area of the display screen are controlled, and the security requirement of the first display content is lower than the security requirement of the second display content. The first display content shown in the first display area is obtained and transmitted to the target device to control the output of the first display content. The visible display area of the display screen can be partitioned to separately output content with different security requirements. The first display content of the first display area is transmitted to the target device to control the output of the first display content on the target device. The output content of the second display area has a higher security requirement and is not transmitted to other devices, thereby ensuring the confidentiality and security of the second display content.

FIG. 21 illustrates a flowchart for controlling the output of the second display content in the second display area of the display screen consistent with various embodiments of the present disclosure. A process of controlling the output of the second display content in the second display area of the display screen includes steps 2101 and 2102, which are described in detail below.

2101: receiving a movement operation for moving a target display interface to the second display area.

The target display interface refers to a display interface of an application with a high security requirement.

After the display screen is partitioned into two display areas, the target display interface is displayed in the first display area by default. The display content on the display screen has not yet been transmitted to the target device. An operator can move the target display interface from the first display area to the second display area according to individual needs.

In one potential embodiment, the movement operation may be a sliding gesture, mouse input, or the like. Based on the sliding gesture or mouse input trajectory, it is determined that a starting position corresponds to a location of the target display interface in the first display area, and an ending position corresponds to a location in the second display area. The movement operation involves relocating the target display interface from the first display area to the second display area.

2102: controlling output of the target display interface in the second display area based on the movement operation.

According to the movement operation, it can be determined that the target display interface is moved from the first display area to the second display area. In response to the movement operation, the target display interface is controlled to be displayed in the second display area.

The second display area can only output the target display interface, and accordingly, the target display interface can be displayed in the second display area.

The second display area can output a plurality of display interfaces. Accordingly, the plurality of display interfaces may be output in different parts of the second display area, or the target display interface recently moved to the second display area may be used as a foreground display interface, while other applications run in the background.

In one embodiment, upon receiving a movement operation to move the target display interface to the second display area, the target display interface is controlled to be displayed in the second display area, allowing the operator to manually move the target display interface to the second display area, ensuring that the target display interface with higher safety requirements is only displayed in the second display area.

FIG. 22 illustrates another flowchart for controlling an output of the second display content in the second display area of the display screen consistent with various embodiments of the present disclosure. A process of controlling the output of the second display content in the second display area of the display screen including steps 2201 and 2202, which are described in detail below.

2201: receiving display setting parameters for setting the target display interface.

The display setting parameters are preset for each application and specifically configure a display of the display interface of each application.

The display setting parameters may specify whether the interface is shown in a specific area or a non-specific area. The specific area refers to a display area with higher security.

In one embodiment, the specific area corresponds to the second display area.

In one potential embodiment, the display setting parameters determine whether the interface is shown in privacy mode or non-privacy mode, with a specific identifier used to differentiate the display modes.

After the two display areas are triggered and determined, an operator may manually set the display setting parameters of the target display interface, which can include enabling a privacy display mode.

By default, the display setting parameters of the display interface are set to non-private display, but an operator can modify them manually.

The display setting parameters may be preset for each application, with a specific identifier indicating whether an application's display interface is set to private or non-private mode. Upon launching the application, the specific identifier is obtained to determine an appropriate display mode for the application's display interface.

Correspondingly, after the display screen is divided into the first display area and the second display area, the display interfaces of one or more applications currently shown on the display screen are identified as private displays based on specific identifiers of the applications. The display interface of a privately displayed application is designated as the target display interface to perform a subsequent step 2202.

2202: controlling output of the target display interface in the second display area based on the display setting parameters characterized for output in the second display area.

The second display area of the display screen is designated as a privacy area. The target display interface is controlled to be output in the second display area according to a previously determined display setting parameters indicating that the application requires a privacy display.

In one embodiment, the display setting parameters of the target display interface are received and configured. Based on a representation of the display setting parameters, the target display interface is controlled to be output in the second display area. By setting the display setting parameters of the target display interface, the target display interface is controlled to be output in the second display area according to the display setting parameters, thereby arranging and controlling the target display interface of an application to be displayed in the second display area, and ensuring that the target display interface, which has ahigh security requirement, is only displayed in the second display area.

The above describes a method for controlling a movable display screen according to the embodiments of the present disclosure. The following describes a device configured to execute the above method for controlling the movable display screen.

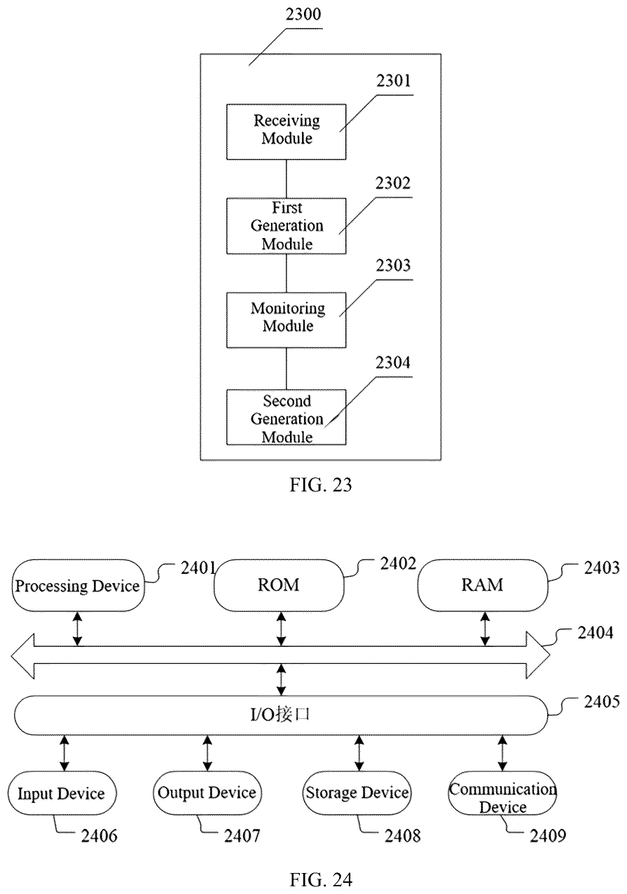

FIG. 23 illustrates a schematic diagram of a control device for a movable display screen consistent with various embodiments of the present disclosure. A control device 2300 of the movable display screen includes: a receiving module 2301, for receiving trigger information that triggers the movement of the display screen; a first generation module 2302, for generating a driving signal based on the trigger information, the driving signal being used to control an operation of the drive motor to drive at least one end of the display screen to move; a monitoring module 2303, for monitoring a state of the target limit switch in the display screen, the target limit switch being configured for limiting the movement of the display screen to a target position; and a second generation module 2304, for generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

In one potential embodiment, the control device 2300 further includes: a data receiving module, for receiving target data sent by a linear encoder after a drive signal is generated based on trigger information, the trigger information being based on a posture of the electronic device corresponding to an allowed movement posture, the target data being generated by the linear encoder based on an operating state of the drive motor; an analysis module, for analyzing the target data to obtain the operating state of the drive motor; a third generation module, for generating a second signal when the operating state of the drive motor meets a predefined abnormal condition, the second signal being configured to control the drive motor to stop operation; and triggering the monitoring module when the operating state of the drive motor does not meet the abnormal condition.

In one potential embodiment, the control device 2300 further includes: an acquisition module, for obtaining a relative positional relationship between an image acquisition device and an acquisition object based on a change in a visible size of the display screen triggered by movement of the display screen of the electronic device, the image acquisition device being arranged at one end of the body where the display screen of the electronic device is located, the display screen of the electronic device including a display area that can be hidden, and movement of the display screen causing the hidden display area to become visible; and an adjustment module, for adjusting a first image captured by the image acquisition device based on the relative positional relationship between the image acquisition device and the acquisition object, so that the acquisition object displayed in the first image satisfies a preset condition.

In one potential embodiment, the adjustment module includes at least one of the following: an adjustment unit, for adjusting an acquisition range of the image acquisition device so that the acquisition object displayed in the first image captured by the image acquisition device satisfies the preset condition; and an interception unit, for intercepting an original image captured by the image acquisition device to obtain the first image in which the acquisition object satisfies the preset condition.

The acquisition object displayed in the first image captured by the image acquisition device satisfies the preset condition, including at least one of the following: a position of the acquisition object in the first image is in a central area of the first image, and a viewing direction of the acquisition object in the first image is toward the display screen.

In one potential embodiment, the control device 2300 further includes a control module configured to control movement of the display screen of the electronic device to trigger changes in the visible size of the display screen. The control module includes: a first control unit, for controlling the display screen of the electronic device to move in a first direction based on a first triggering instruction to cause the hidden display area in the display screen to become visible; and a second control unit, for controlling the display screen of the electronic device to move in a second direction based on a second triggering instruction, so that the visible display area of the display screen become hidden, and the second direction being opposite to the first direction.

The electronic device includes a first body and a second body. The display screen includes a visible display area arranged on the first body and a hideable display area arranged on the second body. The image acquisition device is located at one end of the first body.

In one potential embodiment, the interception unit is specifically configured to: obtain display parameters after a change in the display screen, the display parameters corresponding to a size of the display screen after the change; determine a target interception area based on the display parameters; and intercept the original image according to the target interception area to obtain the first image.

In one potential embodiment, the control device 2300 further includes: a determination module, for determining a first display area and a second display area in the display screen based on the visible size of the display screen upon receiving a partition triggering instruction, the first display area and the second display area constituting the display area of the display screen; a control module, for controlling output of first display content in the first display area and output of the second display content in the second display area, the security requirement of the first display content being lower than the security requirement of the second display content; an acquisition module, for obtaining the first display content output in the first display area; and a sending module, for sending the first display content to a target device to control the target device to output the first display content.

In one potential embodiment, the control module controls the output of second display content in the second display area of the display screen, including at least one of the following operations: receiving a movement operation for moving the target display interface to the second display area and controlling output of the target display interface in the second display area based on the movement operation; or receiving display setting parameters for setting the target display interface and controlling output of the target display interface in the second display area based on the display setting parameters characterized for output in the second display area.

It should be noted that, for functional descriptions of each component of the control device for the movable display screen provided in the embodiment, reference may be made to the corresponding explanations in the above method embodiments, which will not be repeated herein.

In one embodiment, after receiving the trigger information that triggers movement of the display screen, a drive signal is generated based on the trigger information to control an operation of the drive motor. The operation of the drive motor drives at least one end of the display screen to move, thereby causing a change in the visible size of the display screen. During the operation of the drive motor, a state of the target limit switch on the display screen is monitored. The target limit switch is configured to limit movement of the display screen to a target position. When the state of the target limit switch changes from the first state to the second state, indicating that the position of the display screen has changed from not reaching the target position to reaching the target position, a first signal is generated. The first signal is configured to control the drive motor to stop operating, thereby achieving precise control over a movement position of the display screen and preventing incomplete or excessive roll-up and unfolding operations.

FIG. 24 illustrates a schematic diagram of an electronic device consistent with various embodiments of the present disclosure. In one embodiment, an electronic device may include, but is not limited to, a fixed terminal such as a mobile phone, a notebook computer, a personal digital assistant (PDA), a tablet computer (PAD), a desktop computer, or the like. The electronic device shown in FIG. 24 is provided merely as an example and should not be construed as limiting the functions or scope of the embodiment.

As shown in FIG. 24, the electronic device may include a processing device 2401 (such as a central processing unit, a graphics processor, or the like), which performs various operations and processes according to instructions stored in a read-only memory (ROM) 2402 or loaded from a storage device 2408 into a random-access memory (RAM) 2403. When the electronic device is powered on, RAM 2403 stores various programs and data required for the operation of the electronic device. The processing device 2401, ROM 2402 and RAM 2403 are interconnected through a bus 2404. An input/output (I/O) interface 2405 is also connected to the bus 2404.

Generally, the following devices may be connected to the I/O interface 2405: an input device 2406, such as a touch screen, touch pad, keyboard, mouse, camera, microphone, accelerometer, gyroscope, or the like; an output devices 2407, such as a liquid crystal display (LCD), speakers, vibrators, or the like; a storage devices 2408, such as a memory cards, a hard disks, or the like; and a communication device 2409. The communication device 2409 may enable the electronic device to communicate wirelessly or via a wired connection with other devices to exchange data. Although FIG. 24 illustrates an electronic device including various components, the implementation or availability of all illustrated components is not required. More or fewer components may alternatively be implemented or provided.

In one embodiment, a computer program product including computer-readable instructions is provided. When the computer-readable instructions are executed by an electronic device, the electronic device implements any control method for a movable display screen as provided by embodiments of the present disclosure.

In one embodiment, a computer-readable storage medium storing one or more computer programs is provided. When the one or more computer programs are executed by an electronic device, the electronic device implements any control method for a movable display screen as provided by embodiments of the present disclosure.

It should be noted that the device embodiments described above are illustrative only. Units described as separate components may or may not be physically separated. Similarly, components shown as units may or may not correspond to physical units; they may be co-located or distributed across multiple networked units. Some or all of the modules may be selected or combined according to actual needs to achieve objectives of the embodiments. Furthermore, in the accompanying drawings of the device embodiments provided herein, connections between modules indicate communication links, which may be implemented as one or more communication buses or signal lines.

From the above description of the embodiments, a person skilled in the art will understand that the present disclosure may be implemented by software in combination with necessary general-purpose hardware. Alternatively, the present disclosure may be implemented by dedicated hardware, including dedicated integrated circuits, dedicated central processing units (CPUs), dedicated memories, dedicated components, and the like. In general, all functions performed by computer programs can be readily implemented in hardware, and the specific hardware structures used to implement such functions may vary, including analog circuits, digital circuits, or special-purpose circuits. However, in most cases, implementation of the present disclosure in the form of a software program is preferable. Therefore, technical solutions described herein may essentially be embodied as a software product or as the portion that contributes beyond the art. The computer software product may be stored on a computer-readable storage medium, such as a floppy disk, USB flash drive, portable hard drive, read-only memory (ROM), random access memory (RAM), magnetic disk, optical disk, or the like. The software product includes a set of instructions that, when executed by a computing device (such as a personal computer, training device, or network device), enable a device to perform the methods described in the various embodiments of the present disclosure.

In the above embodiments, the implementation may be realized wholly or partially through software, hardware, firmware, or any combination thereof. When implemented using software, the above embodiments may take the form, in whole or in part, of a computer program product.

The computer program product includes one or more computer-readable instructions. When the computer-readable instructions are loaded and executed by a computer, the computer-readable instructions cause the computer to perform, in whole or in part, the processes or functions described in the embodiments of the present disclosure. The computer may be a general-purpose computer, a special-purpose computer, a computer network, or another programmable device. The computer instructions may be stored in, or transmitted from, one computer-readable storage medium to another computer-readable storage medium. For example, the computer instructions may be transmitted from one website, computer, training device or data center to another website, computer, training device or data center via wired means (such as coaxial cable, optical fiber, digital subscriber line (DSL)) or wireless means (such as infrared, Wi-Fi, or microwave communication). The computer-readable storage medium may be any medium accessible by a computer or a data storage device, such as a training device or a data center, that is integrated with one or more available media. The available media may include magnetic media (e.g., floppy disk, hard disk, magnetic tape), optical media (e.g., DVD), or semiconductor media (e.g., solid state disk (SSD)), or the like.

As disclosed, the control method and devices for a movable display screen provided by the present disclosure at least realize the following beneficial effects.

In the control method, after receiving trigger information that initiates the movement of the display screen, a drive signal is generated based on the trigger information to control an operation of the drive motor. The operation of the drive motor causes at least one end of the display screen to move, thereby changing the visible size of the display screen. During the operation of the drive motor, the state of a target limit switch associated with the display screen is monitored. The target limit switch is configured to limit movement of the display screen to a predefined target position. When the state of the target limit switch changes from a first state to a second state, indicating that the display screen has moved from not reaching the target position to reaching the target position, a first signal is generated. The first signal is used to control the drive motor to stop operation, thereby achieving precise control movement of the display screen and preventing insufficient or excessive roll-up and unfolding.

What is claimed is:

1. A control method for a movable display screen, comprising:
receiving trigger information that triggers movement of the display screen;
generating a driving signal based on the trigger information, the driving signal being configured to control operation of a drive motor to drive at least one end of the display screen to move;
monitoring a state of a target limit switch in the display screen, the target limit switch being configured to limit movement of the display screen to a target position; and
generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

2. The control method according to claim 1, further comprising, after generating the driving signal based on the trigger information:
receiving target data sent by a linear encoder, the target data being generated by the linear encoder based on an operating state of the drive motor;
analyzing the target data to obtain the operating state of the drive motor;
generating a second signal when the operating state of the drive motor meets an abnormal condition, the second signal being configured to control the drive motor to stop operation; and
monitoring the state of the target limit switch in the display screen when the operating state of the drive motor does not meet the abnormal condition.

3. The control method according to claim 1, further comprising:
obtaining a relative positional relationship between an image acquisition device and an acquisition object based on a change in a visible size of the display screen triggered by movement of the display screen of an electronic device, the image acquisition device being arranged at one end of a main body of the electronic device where the display screen is located, the display screen including a hideable display area, and the movement of the display screen causing the hideable display area to become visible; and
adjusting a first image captured by the image acquisition device based on the relative positional relationship between the image acquisition device and the acquisition object so that the acquisition object displayed in the first image satisfies a preset condition.

4. The control method according to claim 3, wherein adjusting the first image captured by the image acquisition device so that the acquisition object displayed in the first image satisfies the preset condition includes at least one of following:
adjusting an acquisition range of the image acquisition device so that the acquisition object displayed in the first image satisfies the preset condition; and
intercepting and processing a collected original image to obtain the first image, the acquisition object displayed in the first image satisfying the preset condition, in which the acquisition object displayed in the first image captured by the image acquisition device satisfies the preset condition, including at least one of:
a position of the acquisition object in the first image being located within a central area of the first image; and
a viewing direction of the acquisition object in the first image being toward the display screen.

5. The control method according to claim 3, wherein controlling the movement of the display screen to trigger changes in the visible size of the display screen includes:
controlling the display screen of the electronic device, based on a first triggering instruction, to move in a first direction to make a hidden display area in the display screen visible;
controlling the display screen of the electronic device, based on a second triggering instruction, to move in a second direction so that a visible display area of the display screen is hidden, the second direction being opposite to the first direction; and
the electronic device including a first body and a second body, the display screen including a visible display area arranged on the first body and a hideable display area arranged on the second body, and an image acquisition device being located at an end of the first body.

6. The control method according to claim 4, wherein intercepting and processing the collected original image to obtain the first image includes:
obtaining display parameters after a change of the display screen, the display parameters corresponding to a size of the display screen after the change;
determining a target interception area according to the display parameters; and
intercepting the original image according to the target interception area to obtain the first image.

7. The control method according to claim 1, further comprising:
determining a first display area and a second display area in the display screen based on a partition triggering instruction and a visible size of the display screen, and the first display area and the second display area constituting a display area of the display screen;
controlling output of first display content in the first display area of the display screen and second display content in the second display area of the display screen, and a security requirement of the first display content being lower than a security requirement of the second display content;
obtaining the first display content output in the first display area; and
sending the first display content to a target device to control the target device to output the first display content.

8. The control method according to claim 7, wherein controlling the output of the second display content in the second display area of the display screen includes at least one of following operations:
receiving a movement operation for moving a target display interface to the second display area and controlling output of the target display interface in the second display area based on the movement operation; or
receiving display setting parameters for setting the target display interface, controlling output of the target display interface in the second display area based on the display setting parameters characterized for output in the second display area.

9. An electronic device, comprising:
one or more processors and a memory containing computer-readable instructions that, when being executed, cause the one or more processors to perform:
receiving trigger information that triggers movement of the display screen;
generating a driving signal based on the trigger information, the driving signal being configured to control operation of a drive motor to drive at least one end of the display screen to move;
monitoring a state of a target limit switch in the display screen, the target limit switch being configured to limit movement of the display screen to a target position; and
generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

10. The electronic device according to claim 9, wherein the one or more processors are further configured to perform, after generating the driving signal based on the trigger information,
receiving target data sent by a linear encoder, the target data being generated by the linear encoder based on an operating state of the drive motor;
analyzing the target data to obtain the operating state of the drive motor;
generating a second signal when the operating state of the drive motor meets an abnormal condition, the second signal being configured to control the drive motor to stop operation; and
monitoring the state of the target limit switch in the display screen when the operating state of the drive motor does not meet the abnormal condition.

11. The electronic device according to claim 9, wherein the one or more processors are further configured to perform:
obtaining a relative positional relationship between an image acquisition device and an acquisition object based on a change in a visible size of the display screen triggered by movement of the display screen of an electronic device, the image acquisition device being arranged at one end of a main body of the electronic device where the display screen is located, the display screen including a hideable display area, and the movement of the display screen causing the hideable display area to become visible; and
adjusting a first image captured by the image acquisition device based on the relative positional relationship between the image acquisition device and the acquisition object so that the acquisition object displayed in the first image satisfies a preset condition.

12. The electronic device according to claim 11, wherein adjusting the first image captured by the image acquisition device so that the acquisition object displayed in the first image satisfies the preset condition includes at least one of following:
adjusting an acquisition range of the image acquisition device so that the acquisition object displayed in the first image satisfies the preset condition; and
intercepting and processing a collected original image to obtain the first image, the acquisition object displayed in the first image satisfying the preset condition, in which the acquisition object displayed in the first image captured by the image acquisition device satisfies the preset condition, including at least one of:
a position of the acquisition object in the first image being located within a central area of the first image; and
a viewing direction of the acquisition object in the first image being toward the display screen.

13. The electronic device according to claim 11, wherein the one or more processors are further configured to perform:
controlling the display screen of the electronic device, based on a first triggering instruction, to move in a first direction to make a hidden display area in the display screen visible;
controlling the display screen of the electronic device, based on a second triggering instruction, to move in a second direction so that a visible display area of the display screen is hidden, the second direction being opposite to the first direction; and
the electronic device including a first body and a second body, the display screen including a visible display area arranged on the first body and a hideable display area arranged on the second body, and an image acquisition device being located at an end of the first body.

14. The electronic device according to claim 12, wherein the one or more processors are further configured to perform:
obtaining display parameters after a change of the display screen, the display parameters corresponding to a size of the display screen after the change;
determining a target interception area according to the display parameters; and
intercepting the original image according to the target interception area to obtain the first image.

15. The electronic device according to claim 9, wherein the one or more processors are further configured to perform:
determining a first display area and a second display area in the display screen based on a partition triggering instruction and a visible size of the display screen, and the first display area and the second display area constituting a display area of the display screen;
controlling output of first display content in the first display area of the display screen and second display content in the second display area of the display screen, and a security requirement of the first display content being lower than a security requirement of the second display content;
obtaining the first display content output in the first display area; and
sending the first display content to a target device to control the target device to output the first display content.

16. The electronic device according to claim 15, wherein controlling the output of the second display content in the second display area of the display screen includes at least one of following operations:
receiving a movement operation for moving a target display interface to the second display area and controlling output of the target display interface in the second display area based on the movement operation; or
receiving display setting parameters for setting the target display interface, controlling output of the target display interface in the second display area based on the display setting parameters characterized for output in the second display area.

17. A non-transitory computer readable storage medium containing computer-readable instructions that, when being executed, cause at least one processor to perform:
receiving trigger information that triggers movement of the display screen;
generating a driving signal based on the trigger information, the driving signal being configured to control operation of a drive motor to drive at least one end of the display screen to move;
monitoring a state of a target limit switch in the display screen, the target limit switch being configured to limit movement of the display screen to a target position; and
generating a first signal based on a state of the target limit switch switching from a first state to a second state, the switching of the target limit switch from the first state to the second state indicating that a movement position of the display screen has changed from not reaching the target position to reaching the target position, the first signal being used to control the drive motor to stop operation.

18. The storage medium according to claim 17, wherein the at least one processor is further configured to perform, after generating the driving signal based on the trigger information,
receiving target data sent by a linear encoder, the target data being generated by the linear encoder based on an operating state of the drive motor;
analyzing the target data to obtain the operating state of the drive motor;
generating a second signal when the operating state of the drive motor meets an abnormal condition, the second signal being configured to control the drive motor to stop operation; and
monitoring the state of the target limit switch in the display screen when the operating state of the drive motor does not meet the abnormal condition.

19. The storage medium according to claim 17, wherein the at least one processor is further configured to perform:
obtaining a relative positional relationship between an image acquisition device and an acquisition object based on a change in a visible size of the display screen triggered by movement of the display screen of an electronic device, the image acquisition device being arranged at one end of a main body of the electronic device where the display screen is located, the display screen including a hideable display area, and the movement of the display screen causing the hideable display area to become visible; and
adjusting a first image captured by the image acquisition device based on the relative positional relationship between the image acquisition device and the acquisition object so that the acquisition object displayed in the first image satisfies a preset condition.

20. The storage medium according to claim 19, wherein adjusting the first image captured by the image acquisition device so that the acquisition object displayed in the first image satisfies the preset condition includes at least one of following:
adjusting an acquisition range of the image acquisition device so that the acquisition object displayed in the first image satisfies the preset condition; and
intercepting and processing a collected original image to obtain the first image, the acquisition object displayed in the first image satisfying the preset condition, in which the acquisition object displayed in the first image captured by the image acquisition device satisfies the preset condition, including at least one of:
a position of the acquisition object in the first image being located within a central area of the first image; and
a viewing direction of the acquisition object in the first image being toward the display screen.
